(19) United States
(12) Patent Application Publication
(10) Pub. No.: US 2026/0049194 A1
(43) Pub. Date: Feb. 19, 2026

(54) EXPANDABLE THERMOPLASTIC POLYMER PARTICLES WITH A CONTENT OF RECYCLED MATERIAL, AND METHOD FOR PRODUCING SAME

(71) Applicant: INEOS STYROLUTION GROUP GMBH, Frankfurt am Main (DE)

(72) Inventors: Bianca WILHELMUS, Hanau (DE); Yvonne VAN VEEN, Uithoorn (NL); Johannes MEUCHELBOECK, Bayreuth (DE); Holger RUCKDAESCHEL, Bayreuth (DE); Nick WEINGART, Leverkusen (DE)

(21) Appl. No.: 18/881,908

(22) PCT Filed: Jul. 7, 2023
(86) PCT No.: PCT/EP2023/068818

§ 371 Date: Jan. 7, 2025

(30) Foreign Application Priority Data
Jul. 8, 2022 (EP) 22183839.4

(51) Int. Cl. C08J 9/18; C08J 9/00; C08J 9/14; C08J 9/232

(52) U.S. Cl. CPC C08J 9/18; C08J 9/0061; C08J 9/141; C08J 9/232; C08J 2201/022; C08J 2355/02; C08J 2455/02

(57) ABSTRACT

The invention relates to expandable polymer particles with a content of recycled material based on styrene polymers, to a method for producing same, and to the use of the expandable polymer particles in a molded foam part. The expandable polymer particles contain 10 to 99 wt. %, based on the total weight, of at least one recycled material (A), which comprises at least one styrene polymer (A-1) and which largely consists of styrene polymers. 1 to 10 wt. %, based on the total weight, of at least one propellant (C), and optionally at least one primary polymer (B), at least one nucleating agent (D), and/or at least one additive (E).

The invention relates to expandable polymer particles having a recyclate content based on styrene polymers, to a process for production thereof and to the use of the expandable polymer particles for foam molded parts.

### PRIOR ART

Particle foams have been used for years in numerous applications, including insulation in the construction sector, packaging and structural lightweight wall materials in the automotive sector. Particle foams usually consist of many foamed polymer beads that are welded to one another. Particle foams typically offer the advantage over solid materials of weight reduction coupled with good mechanical properties.

Particle foams made of polyolefins, such as polyethylene, have been known for decades and are described for example in U.S. Pat. No. 6,028,121. CN 107501595A describes a process for producing particles of expanded polypropylene. A disadvantage of particle foams made of polyolefins is that they require complete foaming already during production, since the blowing agent does not remain in the polymer material over a prolonged period. It is not possible to produce polyolefin particles laden with blowing agent that are still expandable after a certain storage time. Production of the particles and processing (foaming) therefore cannot be separated in time and space, though this is desirable in practice. Only polyolefin particles that have already been foamed can be produced and processed. Due to the large total volume, the transportation of such particles is more costly than the transportation of unfoamed products/particles.

It is therefore desirable to provide expandable polymer particles which may be stored over a longer period and can optionally be transported at lower cost. It is additionally desirable for these expandable polymer particles to consist to a large extent of recycled material and preferably also to be easily recyclable themselves, thus allowing them to be supplied to a circular economy.

EP-A 2384355 describes expandable thermoplastic polymer particles containing a styrene polymer and a polyolefin.

Since the polymers used are not miscible with one another, they require the use of a compatibilizer for adjustment of the morphology. The use of polyolefins and compatibilizers is necessary to achieve particle foams of high stiffness and good elasticity, which cannot be achieved with a particle foam consisting solely of polystyrene.

However, the use of polyolefins with a compatibilizer requires at least one additional process step, the production of a blend of at least three components: polystyrene, polyolefin and compatibilizer. In addition, suitable compatibilizers are often complex to produce or expensive. Furthermore, in the context of a simplified recycling of the particle foams at the end of their service life a material consisting of only one polymer type, which may be reintroduced into the corresponding material cycle, is advantageous.

U.S. Pat. No. 4,108,806 describes a process for producing expanded and expandable polymer particles based on a polyolefin matrix into which expandable microspheres are introduced. The microspheres consist of a thermoplastic shell and a core of a volatile liquid blowing agent which, upon heating, brings about an expansion of the polymer composition. This production method is costly and affords a polymer mixture of two or more polymer types.

Polymer foams comprising styrene polymers and copolymers and processes for production thereof are also described in the literature.

WO 2013/085742 describes the provision of an extruded polymer foam composed of styrene-acrylonitrile copolymer (SAN) and produced using a blowing agent mixture of 74-78% by weight of 1,1,1,2-tetrafluoroethane, 13-16% by weight of CO₂ and 7-9% by weight of water. The provision of expandable polymer particles is not disclosed.

U.S. Pat. No. 7,919,538 claims a particle foam consisting of SAN and an additive which shields infrared radiation for the purpose of improved thermal insulation. Expandable polymer particles are not described.

U.S. Pat. No. 3,945,956 describes a process for producing expandable polymer particles where a volatile liquid blowing agent is enclosed in a hollow sphere of a styrene-acrylonitrile copolymer. The blowing agent is enclosed in a polymer particle but not homogeneously distributed in a polymer matrix. Expansion of such polymer particles therefore affords a polymer foam having inhomogeneously distributed cavities.

U.S. Pat. No. 5,480,599 describes a process for producing particle foams, inter alia from styrene polymers. The process makes it possible to effect at least partial recovery of the blowing agent after expansion of the particles. However, the process provides only expanded polymer particles and not expandable particles.

U.S. Pat. No. 5,049,328 describes a process for foam production without organic blowing agents. Only inert gases such as CO₂, nitrogen or air are used as blowing agents. The process is not suitable for providing expandable polymer particles that are amenable to storage for a certain period of time since the gases consisting of small molecules rapidly escape from the polymer composition.

EP-A 0712885 claims expandable beads of acrylonitrile-butadiene-styrene copolymers (ABS). These are produced in a batch process where ABS beads are impregnated with a blowing agent in an autoclave. It is necessary to modify the bead surface with electrolytes in order that the loading of the beads with the blowing agent may be carried out in aqueous medium. This is disadvantageous since the electrolytes remain on the surface and can impair the weldability of the beads. In addition, the amounts producible are limited by the complex coating process, the size of the autoclave required, the batchwise mode of operation and the long loading time with the blowing agent.

EP 2 614111 discloses expandable, vinylaromatic polymers containing 0.5% to 2% by weight of talc and 1% to 5% by weight of carbon black. Vinylaromatic polymers mentioned include polystyrene (PS), styrene-acrylonitrile copolymers (SAN), acrylonitrile-butadiene-styrene copolymers (ABS) or copolymers of styrene and butadiene.

US 2013/059933 teaches a process for producing an expandable pelletized polymer material consisting of a styrene polymer component having a glass transition temperature of ≥130° C. and one or more thermoplastic polymers selected from the group consisting of aromatic polyethers; polyolefins; polyacrylates; polycarbonates; polyesters; polyamides; polyether sulfones; polyether ketones and polyether sulfides. Since the polymer material comprises at least two different polymer classes, the obtained expandable pellet materials are mechanically recyclable only with difficulty, if at all.

DE 10 2012 217668 discloses an expandable polymer pellet material obtainable from:
P) 100 parts by weight of a polymer component consisting of
PS) 90-100% by weight (based on P) of a styrene copolymer component consisting of
PS1) one or more styrene-acrylonitrile copolymers (SAN) or
PS2) a mixture of one or more styrene-acrylonitrile copolymers (SAN) and one or more styrene-maleic anhydride copolymers (SMA) and/or
PS3) one or more styrene-acrylonitrile-maleic anhydride copolymers (SANMA) and PT) 0% to 10% by weight (based on P) of one or more thermoplastic polymers from the group consisting of aromatic polyethers; polyolefins; polyacrylates; polycarbonates (PC); polyesters; polyamides; polysulfones; polyether sulfones (PES); polyether ketones (PEK) and polystyrene;
T) 2 to 8 parts by weight (based on P) of a physical blowing agent component (T) containing 80% to 100% by weight (based on T)) of one or more hydrocarbons having 2 to 7 carbon atoms, F) a flame retardant system containing 1 to 10 parts by weight, based on P, of one or more brominated trialkyl phosphates as flame retardant (F1). The addition of flame retardants and the use of polymers of different polymer classes markedly reduces the recyclability of the expandable polymer pellet material.

DE 10 2012 217665 teaches a process for producing expandable polymer particles from styrene-acrylonitrile copolymers (SAN) admixed with 3.11% to 3.91% by weight of a physical blowing agent.

DE 103 58 801 discloses particle foam molded parts obtainable by welding prefoamed foam particles consisting of expandable thermoplastic polymer pellet materials containing 5-100% by weight of a styrene copolymer A), 0% to 95% by weight of polystyrene B) and 0% to 95% by weight of a thermoplastic polymer C) distinct from a) and b), characterized in that the particle foam has a density in the range from 8 to 100 g/l.

DE 10 2008 023702 teaches a process for continuous production of expandable polymer particles by incorporation of a polymeric stream in a second polymeric stream which contains the expandable system and additives. The addition of additives impedes the recyclability of the polymer foam after the end of its use or service life.

DE 103 58 804 discloses expandable styrene polymer pellet materials having at least bi- or multi-modal molecular weight distribution.

Expandable thermoplastic polymer particles having a low blowing agent loss and high expansion capacity which are processable into particle foams of high stiffness and good elasticity are also described in WO 2022/090403. However, when using ABS good results are attainable only with addition of nucleating agents.

In many applications foamed materials are combined with unfoamed materials. In the context of good recyclability it is desirable for the foamed material and the unfoamed material to consist of the same thermoplastic polymer matrix. At the end of its service life the article may then be comminuted and re-melted without the material suffering any loss of mechanical properties.

In many industrial applications a styrene polymer or copolymer is employed as unfoamed material. It would therefore be desirable to have a compatible material in foamed form too, so that altogether a good recyclability is ensured when both materials are combined in one article. This is achieved for example with a particle foam of a styrene polymer or copolymer.

It would further be desirable to also introduce a large proportion of recycled material back into the particle foam to provide a contribution to the circular economy. Especially the use of recyclate from end-of-life plastics, for example from EE waste, would be desirable to reintroduce this material into the cycle.

However, a common feature of all of the aforementioned disclosures is that they always relate to materials produced from petrochemical primary raw materials. They contain no recycled plastics, in particular no post-consumer recyclates.

Recent years have seen increasing efforts to recycle plastics products at the end of their service life. The use of plastics recyclates offers several advantages over production of plastics from fossil sources, such as energy savings, waste reduction and reduced consumption of resources. However, in order not to suffer loss of quality compared to primary plastics when recyclates are used and to compensate the quality variations of the recyclates used it is advantageous to adjust the properties of the recyclates by means of suitable additives, as described in WO 2021/074084.

KR 101789704 describes the use of recyclates for producing expandable polystyrene particles but the recyclates used are only post-industrial wastes, i.e. wastes which arise, for example, during trimming of molded parts. Post-consumer wastes are not employed.

EP 1 694 753 discloses a process for producing expandable, pelletized thermoplastic polymer materials, from a mixture of 50% to 90% by weight of polystyrene and 10% to 50% by weight of styrene copolymer selected from styrene-butadiene block copolymers, styrene-a-methylstyrene copolymers, acrylonitrile-butadiene-styrene (ABS), styrene-acrylonitrile (SAN), acrylonitrile-styrene acrylate (ASA), methacrylate-butadiene-styrene (MBS) and methyl methacrylate-acrylonitrile-butadiene-styrene (MABS). The document teaches that the styrene polymer melt may also be admixed with polymer recyclates but recites a proportion of not more than 50% by weight, especially 1% to 20% by weight. The mechanical properties of expanded polymer compositions having a high polystyrene content are generally disadvantageous. This also applies to the expandable styrene polymer pellet material described in EP 1 694 755 comprising at least 70% by weight of polystyrene and 0.1% to 30% by weight of a low molecular weight styrene copolymer consisting of styrene, acrylic acid and alpha-methylstyrene.

There is a high demand for expandable polymer particles and for processes for providing expandable polymer particles which can be stored for a certain amount of time and optionally transported at minimum cost and also consist only of a single polymer class to simplify recycling. The polymer particles should further include a high proportion of recycled polymer material in order to keep the material streams very largely in a closed loop. Furthermore, after expansion the cavities in the expanded polymer particles should be very largely homogeneously distributed and exhibit a fine-celled foam structure. It should also be possible to produce molded parts with sufficiently good mechanical properties and good thermal insulation efficiency from the expandable polymer particles.

It is accordingly an object of the present invention to provide expandable, thermoplastic, polymer particles with low blowing agent loss and high expansion capacity which are made of a high proportion of recyclates and can themselves also be easily recycled again and which may be processed into particle foams of high stiffness coupled with good elasticity. It is a further object to provide a process for producing such expandable thermoplastic polymer particles.

It has been found that, surprisingly, this object is achievable by production of the inventive expandable thermoplastic polymer particles more particularly elucidated in the claims, the description which follows and the examples.

The expandable thermoplastic polymer particles according to the invention contain:
A) 10% to 99% by weight, based on the total weight of (A), (B), (C), (D) and (E), of at least one recyclate (A) which comprises at least one styrene polymer (A-1) and consists predominantly of styrene polymers;
B) 0% to 89% by weight, based on the total weight of (A), (B), (C), (D) and (E), of at least one primary polymer (B) which comprises at least one styrene polymer (B-1),
C) 1% to 10% by weight, based on the total weight of (A), (B), (C), (D) and (E), of at least one blowing agent (C);
D) 0% to 3% by weight, based on the total weight of (A), (B), (C), (D) and (E), of at least one nucleating agent (D); and
E) 0% to 8% by weight, based on the total weight of (A), (B), (C), (D) and (E), of at least one additive (E);
wherein the sum of (A) and (B) accounts for 79% to 99% by weight, based on the total weight of (A), (B), (C), (D) and (E), and

wherein the expandable thermoplastic polymer particle contains substantially no further polymers in addition to the at least one recyclate (A) and the at least one primary polymer (B). This means that the expandable thermoplastic polymer particles contain not more than 5% by weight, preferably not more than 3% by weight, often not more than 1% by weight, based on the total weight of (A), (B), (C), (D) and (E), of polymers which do not conform to the definition of the recyclate (A) and the primary polymer (B). The expandable thermoplastic polymer particles preferably contain 0% by weight, based on the total weight of (A), (B), (C), (D) and (E), of polymers which do not conform to the definition of the recyclate (A) and the primary polymer (B). The small amount of foreign polymers improves the recyclability of the expandable polymer particles according to the invention.

The term “styrene polymers” is to be understood as meaning polymers having repeating units of styrene monomers incorporated in their polymer chain. The styrene polymers according to the invention are especially selected from the group consisting of styrene-acrylonitrile copolymers (SAN), acrylonitrile-butadiene-styrene copolymers (ABS), acrylate-styrene-acrylonitrile copolymers (ASA), styrene-butadiene block copolymers (SBC), methyl methacrylate-acrylonitrile-butadiene-styrene copolymers (MABS), methyl methacrylate-butadiene-styrene copolymers (MBS), α(alpha)-methylstyrene-acrylonitrile copolymers (AMSAN), styrene-methyl methacrylate copolymers (SMMA), amorphous polystyrene (PS) and impact-modified polystyrene (HIPS).

The expandable thermoplastic polymer particles contain at least 10% by weight, often at least 20% by weight, preferably at least 30% by weight, especially at least 40% by weight, often more than 50% by weight, based on the total weight of (A), (B), (C), (D) and (E), of at least one recyclate (A) which comprises at least one styrene polymer (A-1) and consists predominantly of styrene polymers. The expandable thermoplastic polymer particles contain not more than 99% by weight, typically not more than 98% by weight, often not more than 89% by weight, preferably not more than 84% by weight, often not more than 79% by weight, based on the total weight of (A), (B), (C), (D) and (E), of the at least one recyclate (A). The expandable thermoplastic polymer particles often contain 40% to 79% by weight, preferably 45% to 74% by weight, often 51% to 72% by weight, based on the total weight of (A), (B), (C), (D) and (E), of the at least one recyclate (A).

The expandable thermoplastic polymer particles optionally contain at least 1% by weight, often at least 10% by weight, preferably at least 15% by weight, often at least 20% by weight, based on the total weight of (A), (B), (C), (D) and (E), of at least one primary polymer (B) which comprises at least one styrene polymer (B-1) or consists of at least one styrene polymer (B-1). The expandable thermoplastic polymer particles contain not more than 89% by weight, typically not more than 79% by weight, often not more than 69% by weight, preferably not more than 59% by weight, often less than 49% by weight, based on the total weight of (A), (B), (C), (D) and (E), of the at least one primary polymer (B). The expandable thermoplastic polymer particles often contain 20% to 59% by weight, preferably 25% to 54% by weight, often 27% to 48% by weight, based on the total weight of (A), (B), (C), (D) and (E), of the at least one primary polymer (B).

The expandable thermoplastic polymer particles preferably comprise less than 5% by weight, especially less than 3% by weight, based on the total weight of (A), (B), (C), (D) and (E), of polymers comprising no styrene-derived repeating units. However, small amounts of impurities in the form of polymers comprising no styrene-derived repeating units may be introduced through incompletely single-variety separation in the recycling process when obtaining the recyclates (A).

In the context of the present invention recyclate (A) is defined as plastics whose origin derives from plastics articles which have been sent for recycling and processing at the end of their service life. Processing into recyclate may be carried out by various processes known in industry, see for example Köhnlechner, R. (2014): “Erzeugung sauberer PS-und ABS-Fraktionen aus gemischtem Elektronikschrott”, in D. G. Karl J. Thomé-Kozmiensky (Ed.), Recycling und Rohstoffe, volume 7 (pp. 379-400), TK Verlag Karl Thome-Kozmiensky, Neuruppin. The production of the recyclates may especially have comprised the addition of additives and/or primary materials to achieve a required material quality.

The recyclates (A) thus differ from the primary polymers (B) especially in that the recyclates (A) have passed through at least one separate thermal compounding step before use in the expandable thermoplastic polymer particles according to the invention, for example an extrusion process or an injection molding process. In contrast to the primary polymers (B) the recyclates (A) have thus been subjected at least once to mechanical stress by mixing, in particular through shear forces, for example in an extruder, for example single-screw or twin-screw extruders, or in other conventional plasticizing apparatuses, such as Brabender mills or Banbury mixers, at a temperature above the melting range temperature of the recyclate (A), for example at a temperature in a range from 180° C. to 320° C., often in a range from 200° C. to 300° C., for example 220° C. to 280° C., determined according to ISO 294. The recyclates (A) may also have been subjected to other processing steps in which the recyclate (A) has been subjected to mechanical stress at temperatures below the melting range temperature, for example calendering.

The at least one recyclate (A) comprises at least one styrene polymer (A-1) and consists predominantly of styrene polymers. It is preferable when the recyclate (A) consists to an extent of at least 80% by weight, often to an extent of at least 85% by weight, preferably to an extent of at least 90% by weight or at least 92% by weight, based on the recyclate (A), of at least one styrene polymer (A-1).

In addition to the styrene polymer (A-1) the recyclate (A) may often also contain further constituents which have been added to the composition of the recyclate for the primary use or have passed into the recyclate (A) due to inadequate separation during the recycling process. In addition to the styrene polymers the recyclates (A) may contain further components (A-2) such as additives, pigments, foreign polymers or contaminants such as metal parts, especially aluminum particles.

It is preferable when the recyclate (A) contains no substances which have an adverse effect on the further use according to the invention. These include especially halogen-containing flame retardants. The components (A-2) generally account for not more than 20% by weight, often not more than 15% by weight, preferably not more than 10% by weight or not more than 8% by weight, based on the recyclate (A), of the recyclate (A). It is preferable when the recyclate (A) comprises substantially no further polymers. This means that the recyclate (A) contains not more than 5% by weight, preferably not more than 3% by weight, often not more than 1% by weight, based on the total weight of the recyclate (A), of polymers which do not conform to the definition of the styrene polymer (A-1). It is preferable when the recyclate (A) contains 0% by weight, based on the total weight of the recyclate (A), of polymers which do not correspond to the definition of the styrene polymer (a-1). The small amount of foreign polymers improves the recyclability of the expandable polymer particles according to the invention.

In the context of the present invention the terms primary material and primary polymers refer to plastics that have been produced from fossil raw materials and have not yet been recycled during their service life.

The at least one primary polymer (B) comprises or consists of at least one styrene polymer (B-1). It is preferable when the primary polymer (B) comprises at least 80% by weight, often at least 85% by weight, preferably at least 90% by weight or at least 92% by weight, based on the primary polymer (B), of at least one styrene polymer (B-1). The primary polymer (B) may additionally contain components (B-2) which are typically used during production of the styrene polymers and are used for example to improve processability. Examples of component (B-2) include additives such as lubricants and demolding agents. In one embodiment of the invention the primary polymer comprises 100% by weight, based on the primary polymer (B), of at least one styrene polymer (B-1). The primary polymer of this embodiment accordingly comprises 0% by weight, based on the primary polymer (B), of a component (B-2). It is preferable when the primary polymer (B) contains substantially no further polymers. This means that the primary polymer (B) contains not more than 5% by weight, preferably not more than 3% by weight, often not more than 1% by weight, based on the total weight of the primary polymer (B), of polymers which do not conform to the definition of the styrene polymer (B-1). It is preferable when the primary polymer (B) contains 0% by weight, based on the total weight of the primary polymer (B), of polymers which do not correspond to the definition of the styrene polymer (B-1). The small amount of foreign polymers improves the recyclability of the expandable polymer particles according to the invention.

In one embodiment the expandable thermoplastic polymer particles consist of the at least one recyclate (A) and the at least one blowing agent (C). In a further embodiment the expandable thermoplastic polymer particles consist of the at least one recyclate (A), the at least one primary polymer (B) and the at least one blowing agent (C). In a further embodiment the expandable thermoplastic polymer particles consist of the at least one recyclate (A), the at least one blowing agent (C) and the at least one nucleating agent (D). In a further embodiment the expandable thermoplastic polymer particles consist of the at least one recyclate (A), the at least one primary polymer (B), the at least one blowing agent (C) and the at least one nucleating agent (D). In a further embodiment the expandable thermoplastic polymer particles consist of the at least one recyclate (A), the at least one blowing agent (C) and the at least one additive (E).

In a further embodiment the expandable thermoplastic polymer particles consist of the at least one recyclate (A), the at least one primary polymer (B), the at least one blowing agent (C) and the at least on additive (E). In a further embodiment the expandable thermoplastic polymer particles consist of the at least one recyclate (A), the at least one blowing agent (C), the at least one nucleating agent (D) and the at least one additive (E).

In a further embodiment the expandable thermoplastic polymer particles consist of the at least one recyclate (A), the at least one primary polymer (B), the at least one blowing agent (C), the at least one nucleating agent (D) and the at least one additive (E).

In a particularly preferred embodiment the at least one recyclate (A) and the at least one primary polymer (B) comprise or consist of polymers belonging to the same polymer class. In this embodiment the expandable polymer particles according to the invention are particularly readily recyclable, for example in mechanical recycling processes. In a further embodiment the at least one recyclate (A) and the at least one primary polymer (B) comprise or consist of polymers belonging to polymer classes that are miscible with one another. This too ensures good recyclability, for example in mechanical recycling processes. “Polymer classes” are to be understood as meaning polymers that are constructed from repeating units of the same monomers.

In this context “miscible” is to be understood as meaning that no domains of a first polymer in a continuous matrix of a second polymer are formed, i.e. the first polymer is dissolved in the second polymer.

In the context of the present application the term “miscible polymer classes” is also to be understood as meaning polymers which form polymer blends in which a continuous phase and a discontinuous phase are formed but the discontinuous phase has domains having an average domain size of less than 5 μm. It is preferable when the primary polymer (B) is dispersed in the form of discontinuous phase domains in a continuous phase of the recyclate (A), wherein the discontinuous phase domains of the primary polymer (B) comprise at most phase domains having an average diameter of ≤2 μm, more preferably ≤200 nm, often≤100 nm.

The expandable thermoplastic polymer particles contain altogether 79% to 99% by weight, based on the total weight of (A), (B), (C), (D) and (E), of at least one recyclate (A) and optionally at least one primary polymer (B) which comprise styrene polymers (A-1) or styrene polymers (B-1), wherein the styrene polymers (A-1) and styrene polymers (B-1) are preferably selected from the group consisting of styrene-acrylonitrile copolymers (SAN), acrylonitrile-butadiene-styrene copolymers (ABS), acrylate-styrene-acrylonitrile copolymers (ASA), styrene-butadiene block copolymers (SBC), methyl methacrylate-acrylonitrile-butadiene-styrene copolymers (MABS), methyl methacrylate-butadiene-styrene copolymers (MBS), α(alpha)-methylstyrene-acrylonitrile copolymers (AMSAN), styrene-methyl methacrylate copolymers (SMMA), styrene-maleic anhydride copolymers (SMA), styrene-acrylonitrile-maleic anhydride copolymers (SANMA), styrene-N-phenylmaleimide copolymers, styrene-acrylonitrile-N-phenylmaleimide copolymers, styrene-imide-maleic anhydride copolymers, styrene-imide-acrylonitrile-maleic anhydride copolymers, amorphous polystyrene (PS) and impact-modified polystyrene (HIPS). It is preferable when the styrene polymers (A-1)/styrene polymers (B-1) are selected from the group consisting of styrene-acrylonitrile copolymers (SAN), acrylonitrile-butadiene-styrene copolymers (ABS) or acrylonitrile-styrene-acrylate copolymers (ASA).

In one embodiment the expandable thermoplastic polymer particles comprise at least 86% by weight, often at least 91.5% by weight, based on the total weight of (A), (B), (C), (D) and (E), of at least one recyclate (A) and optionally at least one primary polymer (B). In one embodiment the expandable thermoplastic polymer particles comprise up to 98.5% by weight, often at least 98% by weight, based on the total weight of (A), (B), (C), (D) and (E), of at least one recyclate (A) and optionally at least one primary polymer (B). The expandable thermoplastic polymer particles often comprise 91% to 98% by weight, particularly preferably 93.5% to 97% by weight, based on the total weight of (A), (B), (C), (D) and (E), of at least one recyclate (A) and optionally at least one primary polymer (B).

In one embodiment the recyclate (A) and the primary polymer (B) contain less than 50% by weight, preferably less than 25% by weight, more preferably less than 10% by weight, based on the recyclate (A) and the primary polymer (B), of styrene homopolymer. In one embodiment the recyclate (A) and the primary polymer (B) contain no styrene homopolymer. In one embodiment the expandable thermoplastic polymer particles contain no other polymers in addition to the recyclate (A) and optionally the primary polymer (B) which preferably contain no styrene homopolymer.

In one embodiment the recyclate (A) and the primary polymer (B) contain less than 50% by weight, preferably less than 25% by weight, more preferably less than 10% by weight, based on the recyclate (A) and the primary polymer (B), of copolymers comprising maleic anhydride and/or maleimide. In one embodiment the recyclate (A) and the primary polymer (B) contain no copolymers comprising maleic anhydride and/or maleimide. In a further preferred embodiment the expandable thermoplastic polymer particles contain no other polymers in addition to the recyclate (A) and optionally the primary polymer (B) which preferably contain no copolymers comprising maleic anhydride and/or maleimide.

In one embodiment the recyclate (A) and the primary polymer (B) contain less than 50% by weight, preferably less than 25% by weight, more preferably less than 10% by weight, based on the recyclate (A) and the primary polymer (B), of styrene-maleic anhydride copolymer (SMA). In a further embodiment the recyclate (A) and the primary polymer (B) contain no styrene-maleic anhydride copolymer (SMA). In a further preferred embodiment the expandable thermoplastic polymer particles contain no other polymers in addition to the recyclate (A) and optionally the primary polymer (B) which preferably contain no styrene-maleic anhydride copolymer (SMA).

In a further alternative embodiment the recyclate (A) and the primary polymer (B) contain less than 50% by weight, preferably less than 25% by weight, more preferably less than 10% by weight, based on the recyclate (A) and the primary polymer (B), of α(alpha)-methylstyrene-acrylonitrile copolymer (AMSAN). In a further embodiment the recyclate (A) and the primary polymer (B) contain no α(alpha)-methylstyrene-acrylonitrile copolymer (AMSAN). In a further preferred embodiment the expandable thermoplastic polymer particles contain no other polymers in addition to the recyclate (A) and optionally the primary polymer (B) which preferably contain no α(alpha)-methylstyrene-acrylonitrile copolymer (AMSAN).

In a further alternative embodiment the recyclate (A) and the primary polymer (B) contain less than 50% by weight, preferably less than 25% by weight, more preferably less than 10% by weight, based on the recyclate (A) and the primary polymer (B), of styrene-isoprene-styrene block copolymer (SIS). In a further embodiment the recyclate (A) and the primary polymer (B) contain no styrene-isoprene-styrene block copolymer (SIS). In a further preferred embodiment the expandable thermoplastic polymer particles contain no other polymers in addition to the recyclate (A) and optionally the primary polymer (B) which preferably contain no styrene-isoprene-styrene block copolymer (SIS).

In one embodiment the recyclate (A) and the primary polymer (B) contain less than 50% by weight, preferably less than 25% by weight, more preferably less than 10% by weight, based on the recyclate (A) and the primary polymer (B), of styrene-acrylonitrile copolymer (SAN). In one embodiment the recyclate (A) and the primary polymer (B) contain no styrene-acrylonitrile copolymer (SAN). In a further embodiment the expandable thermoplastic polymer particles contain no other polymers in addition to the recyclate (A) and optionally the primary polymer (B) which preferably contain no styrene-acrylonitrile copolymer (SAN).

In a further alternative embodiment the recyclate (A) and the primary polymer (B) contain only styrene polymers of the same polymer class selected from the group consisting of styrene-acrylonitrile copolymers (SAN), acrylonitrile-butadiene-styrene copolymers (ABS), acrylate-styrene-acrylonitrile copolymers (ASA), styrene-butadiene block copolymers (SBC), methyl methacrylate-acrylonitrile-butadiene-styrene copolymers (MABS), methyl methacrylate-butadiene-styrene copolymers (MBS), α(alpha)-methylstyrene-acrylonitrile copolymers (AMSAN), styrene-methyl methacrylate copolymers (SMMA), styrene-maleic anhydride copolymers (SMA), styrene-acrylonitrile-maleic anhydride copolymers (SANMA), styrene-N-phenylmaleimide copolymers, styrene-acrylonitrile-N-phenylmaleimide copolymers, styrene-imide-maleic anhydride copolymers, styrene-imide-acrylonitrile-maleic anhydride copolymers, amorphous polystyrene (PS) and impact-modified polystyrene (HIPS).

In a further alternative embodiment the recyclate (A) and the primary polymer (B) contain only styrene polymers of the same polymer class selected from the group consisting of styrene-acrylonitrile copolymers (SAN), acrylonitrile-butadiene-styrene copolymers (ABS), acrylate-styrene-acrylonitrile copolymers (ASA) and α(alpha)-methylstyrene-acrylonitrile copolymers (AMSAN).

In a further alternative embodiment the recyclate (A) and the primary polymer (B) contain only styrene polymers of the same polymer class selected from the group consisting of acrylonitrile-butadiene-styrene copolymers (ABS) and acrylate-styrene-acrylonitrile copolymers (ASA), preferably acrylonitrile-butadiene-styrene copolymers (ABS).

In a further alternative embodiment the recyclate (A) and the primary polymer (B) contain polymer blends comprising styrene-acrylonitrile copolymers (SAN) and acrylonitrile-butadiene-styrene copolymers (ABS); styrene-acrylonitrile copolymers (SAN) and acrylate-styrene-acrylonitrile copolymers (ASA): α(alpha)-methylstyrene-acrylonitrile copolymers (AMSAN) and acrylonitrile-butadiene-styrene copolymers (ABS); or α(alpha)-methylstyrene-acrylonitrile copolymers (AMSAN) and acrylate-styrene-acrylonitrile copolymers (ASA). Particular preference is given to polymer blends comprising styrene-acrylonitrile copolymers (SAN) and acrylonitrile-butadiene-styrene copolymers (ABS).

In one embodiment of the invention, the expandable thermoplastic polymer particles comprise less than 5% by weight, preferably less than 3% by weight, often less than 2% by weight, based on the total weight of (A), (B), (C), (D) and (E), of other thermoplastic polymers, especially selected from the group consisting of polyamides (PA), polyolefins such as polypropylene (PP) or polyethylene (PE), polyacrylates such as polymethyl methacrylate (PMMA), polycarbonate (PC), polyesters such as polyethylene terephthalate (PET) or polybutylene terephthalate (PBT), polyether sulfone (PES), polyether ketones (PEK), polyether sulfides (PES), polylactates, polyphenylene ethers (PPO/PPE), ethylene-vinyl acetate copolymers (EVA), styrene-ethylene-butylene-styrene copolymers (SEBS), styrene-ethylene-propylene copolymers (SEP) and styrene-butyl acrylate copolymers. It is preferable when the expandable thermoplastic polymer particles comprise no thermoplastic polymers selected from the group consisting of polyamides (PA), polyolefins such as polypropylene (PP) or polyethylene (PE), polyacrylates such as polymethyl methacrylate (PMMA), polycarbonate (PC), polyesters such as polyethylene terephthalate (PET) or polybutylene terephthalate (PBT), polyether sulfone (PES), polyether ketones (PEK), polyether sulfides (PES), polylactates, polyphenylene ethers (PPO/PPE), ethylene-vinyl acetate copolymers (EVA), styrene-ethylene-butylene-styrene copolymers (SEBS), styrene-ethylene-propylene copolymers (SEP) and styrene-butyl acrylate copolymers.

The styrene polymers of the invention typically have a weight-average molecular weight Mw in a range from 10 000 g/mol to 1 000 000 g/mol, preferably in a range from 50 000 to 500 000 g/mol, often in a range from 80 000 to 250 000 g/mol. The molecular weight Mw may be determined by gel permeation chromatography (GPC) using tetrahydrofuran (THF) as eluent and with polystyrene calibration.

In one embodiment of the invention the styrene polymer of the recyclate (A) has a weight-average molecular weight Mw which differs by not more than 75%, preferably not more than 50%, often not more than 30%, from the weight-average molecular weight Mw of the styrene polymer of the primary polymer (B). This means that for example at a weight-average molecular weight Mw of the styrene polymer of the recyclate (A) of 100 000 g/mol the weight-average molecular weight Mw of the primary polymer (B) is in a range from 25 000 g/mol to 175 000 g/mol, preferably 50 000 g/mol to 150 000 g/mol, often 70 000 g/mol to 130 000 g/mol.

The styrene polymers according to the invention typically have a melt volume flow rate MVR (220° C./10 kg) according to ISO 1133 of 1 to 30 cm³/10 min, preferably 10 to 25 cm³/10 min.

It is preferable when the blowing agent (component C) is homogeneously distributed in the expandable thermoplastic polymer particles in a polymer matrix composed of the one or more recyclates (A) and the optional at least one primary polymer (B).

As blowing agent (component (C)) the expandable thermoplastic polymer particles contain 1% to 10% by weight, preferably 1.5% to 7% by weight, particularly preferably 2% to 5% by weight, based on the total weight of (A), (B), (C), (D) and (E), of at least one physical blowing agent, for example an inorganic physical blowing agent such as CO₂ or nitrogen, and/or an organic physical blowing agent such as aliphatic C3 to C8 hydrocarbons, alcohols, ketones, ethers or halogenated hydrocarbons, preferably CO₂ or alternatively isobutane, n-butane, isopentane, n-pentane, cyclopentane, or mixtures thereof. The blowing agent preferably comprises at least one organic physical blowing agent.

In a preferred embodiment the blowing agent comprises less than 5% by weight, more preferably less than 2% by weight, based on the total weight of component (C), of water. It is preferable if the blowing agent is substantially free from water, i.e. it comprises not more than 0.5% by weight, preferably not more than 0.1% by weight, based on the total weight of component (C), of water.

As optional component D the expandable thermoplastic polymer particles contain 0% to 3% by weight, preferably 0% to 2% by weight, particularly preferably 0% to 0.5% by weight, based on the total weight of (A), (B), (C), (D) and (E), of at least one nucleating agent, for example talc, aluminum oxide or silicon dioxide.

In a preferred embodiment the expandable thermoplastic polymer particles have no talc, aluminum oxide or silicon dioxide added to them as component (D) during production. In a further embodiment the expandable thermoplastic polymer particles have no nucleating agent added to them as component (D) during production, i.e. 0% by weight based on the total weight of (A), (B), (C), (D) and (E). It is nevertheless possible for the expandable thermoplastic polymer particles to contain nucleating agents which derive especially from the recyclate (A). It has been found that the additives and impurities optionally present in the recyclate (A) are generally sufficient to induce the desired pore formation in the expandable thermoplastic polymer particles.

The expandable thermoplastic polymer particles according to the invention may optionally contain further additives (E) in amounts which do not impair pore formation and the foam structure resulting therefrom. The expandable thermoplastic polymer particles according to the invention often comprise at least one additive (E) in amounts of 0% to 8% by weight, preferably 0% to 5% by weight, more preferably 0% to 3% by weight, for example 0.1% to 3% by weight, based on the total weight of (A), (B), (C), (D) and (E).

Suitable additives (E) are known to those skilled in the art and comprise for example plasticizers, flame retardants, preferably non-halogenated flame retardants, soluble and insoluble inorganic and/or organic dyes and pigments, fillers or reinforcers (glass fibers, carbon fibers, etc.), co-blowing agents, antioxidants, heat stabilizers, UV stabilizers, peroxide scavengers, antistats, lubricants, demolding agents, antiblocking agents, processing auxiliaries and combinations of two or more thereof.

In a preferred embodiment the expandable thermoplastic polymer particles comprise no halogenated flame retardants. Preferred flame retardants especially comprise components based on phosphorus compounds known for this application.

Examples of antioxidants and heat stabilizers include halides of metals of group I of the Periodic Table of the Elements, for example sodium, potassium and/or lithium halides, optionally in conjunction with copper (I) halides, for example chlorides, bromides, iodides, sterically hindered phenols, hydroquinones, various substituted representatives of these groups and mixtures thereof in concentrations up to 1% by weight based on the total weight of the expandable thermoplastic polymer particles.

UV stabilizers generally present in amounts of up to 2% by weight, often 0.1% to 1.5% by weight, based on the total weight of the expandable thermoplastic polymer particles include various substituted resorcinols, salicylates, benzotriazoles and benzophenones.

The thermoplastic polymer particles may further contain organic dyes such as nigrosine, pigments such as titanium dioxide, phthalocyanines, ultramarine blue and carbon black as dyes as well as fibrous and pulverulent fillers and reinforcers. Examples of the latter include carbon fibers, glass fibers, amorphous silica, calcium silicate (wollastonite), aluminum silicate, magnesium carbonate, kaolin, chalk, powdered quartz, mica and feldspar.

Lubricants and demolding agents which may generally be employed in amounts of up to 1% by weight, often 0.1% to 0.8% by weight, based on the total weight of the expandable thermoplastic polymer particles include for example long-chain fatty acids such as stearic acid or behenic acid, their salts (for example Ca or Zn stearate) or esters (for example stearyl stearate or pentaerythritol tetrastearate) as well as amide derivatives (for example ethylenebisstearylamide).

Mineral-based antiblocking agents may also be present in amounts of up to 0.1% by weight based on the total weight of the expandable thermoplastic polymer particles. Examples that may be mentioned include amorphous or crystalline silica, calcium carbonate or aluminum silicate.

Processing auxiliaries that may be present may include for example mineral oil, preferably medical white oil, in amounts of up to 5% by weight, preferably up to 2% by weight, especially 0.1% to 2% by weight, based on the total weight of the expandable thermoplastic polymer particles.

Examples of plasticizers include dioctyl phthalate, dibenzyl phthalate, butyl benzyl phthalate, hydrocarbon oils, N-(n-butyl)benzenesulfonamide and 0- and p-tolylethylsulfonamide.

### Process for Production

The present invention provides a process for producing expandable thermoplastic polymer particles comprising the steps of:
a) admixing the at least one recyclate (A) or a mixture of the at least one recyclate (A) and the at least one primary polymer (B) with the at least one blowing agent (C) and optionally the at least one nucleating agent (D) and/or the at least one additive (E) to form a polymer mixture (I);
b) pelletizing the blowing agent-laden polymer mixture (I) to obtain expandable polymer particles; and
c) optionally pre-expanding the expandable polymer particles.

The foregoing relating to the selection of components (A), (B), (C), (D) and (E) and to the amounts to be employed applies correspondingly to the process according to the invention

In one embodiment the process according to the invention employs only the at least one recyclate (A) and the at least one blowing agent (C) as starting materials. In a further embodiment the process employs only the at least one recyclate (A), the at least one primary polymer (B) and the at least one blowing agent (C) as starting materials. In a further embodiment the process employs only the at least one recyclate (A), the at least one blowing agent (C) and the at least one nucleating agent (D). In a further embodiment the process employs only the at least one recyclate (A), the at least one primary polymer (B), the at least one blowing agent (C) and the at least one nucleating agent (D). In a further embodiment the process employs only the at least one recyclate (A), the at least one blowing agent (C), the at least one nucleating agent (D) and the at least one additive (E). In a further embodiment the process employs only the at least one recyclate (A), the at least one primary polymer (B), the at least one blowing agent (C), the at least one nucleating agent (D) and the at least one additive (E). In a further embodiment the process employs only the at least one recyclate (A), the at least one blowing agent (C) and the at least one additive (E). In a further embodiment the process employs only the at least one recyclate (A), the at least one primary polymer (B), the at least one blowing agent (C) and the at least one additive (E).

It is preferable when process step a) is carried out at a temperature above the glass transition temperature of the at least one recyclate (A) or of the mixture of the at least one recyclate (A) and the at least one primary polymer (B). The temperature in process step a) is often in a range from 150° C. to 250° C., often in a range from 170° C. to 220° C.

It is preferable when at least process step b), often process steps b) and c), are performed at a temperature around the glass transition temperature of the at least one recyclate (A) or of the mixture of the at least one recyclate (A) and the at least one primary polymer (B). The temperature in process step b) and optionally c) is often in a range from 50° C. to 250° C.

It is preferable when at least process step a), particularly preferably process steps a) and b), are carried out under a pressure which exceeds atmospheric pressure.

Process step c) is preferably carried out under a pressure which does not exceed atmospheric pressure.

In one embodiment of the invention process steps a) and b) are performed in an extruder with subsequent underwater pelletization at a water pressure in the range from 1.5 to 11 bar. The water temperature during underwater pelletization is below the glass transition temperature of the at least one recyclate (A) or the mixture of the at least one recyclate (A) and the at least one primary polymer (B) is often in a range from 20° C. to 80° C. The extruder temperature is above the glass transition temperature of the at least one recyclate (A) or the mixture of the at least one recyclate (A) and the at least one primary polymer (B), often in a range from 170° C. to 250° C.

In a further embodiment process steps a) and b) are carried out in an autoclave. The at least one pelletized recyclate (A) or the pelletized mixture of the at least one recyclate (A) and the at least one primary polymer (B), optionally admixed with at least one nucleating agent (D) and/or at least one additive (E), is impregnated with the blowing agent (C) under pressure to afford expandable thermoplastic polymer particles. These may then be isolated or obtained directly by decompression as prefoamed foam particles.

Particular preference is given to a continuous process in which in process step a) a recyclate (A), for example recycled SAN (rSAN), recycled ABS (rABS) or recycled ASA (rASA), and optionally a primary polymer (B), for example SAN, ABS or ASA, optionally mixed with the nucleating agent (D) and/or additives (E), is melted in a twin-screw extruder and impregnated with the blowing agent (C). A preferred embodiment is the use of an already separately produced mixture of the recyclate (A) and the primary polymer (B) which has optionally already been adjusted to a desired material quality by addition of additives.

In process step b) the blowing agent-laden melt can then be extruded through an appropriate die and cut to afford foam sheets, strands or particles. A preferred embodiment is extrusion through a microperforated plate comprising one, or generally more, holes having a hole diameter of 0.1 to 2.4 mm, preferably 0.2 to 1.2 mm, particularly preferably from 0.5 to 0.8 mm, to form particles. In a preferred embodiment the melt issuing from the microperforated plate is passed into a water stream where the melt is cut into individual particles by a suitable apparatus. The adjustment of the suitable counterpressure and a suitable temperature in the water stream of this so-called underwater pelletization allows targeted production of expandable polymer particles.

In an alternative embodiment process steps a) and/or b) may be carried out entirely or partially in a suspension. The recyclate (A) and optionally primary polymer(s) (B), nucleating agent(s) D and/or additive(s) (E) may be converted into a suspension, preferably an aqueous suspension, which is subsequently laden with at least one gaseous blowing agent (C) such as CO₂ or nitrogen under elevated pressure. The pressure at which the blowing agent (C) is introduced is for example in the range from 1 bar to 20 bar and often in the range from 1.2 bar to 15 bar or 1.5 bar to 10 bar. Once the desired loading with blowing agent (C) has been achieved the obtained polymer particles are isolated, for example by filtration and/or centrifugation, and optionally washed.

The optional pre-expansion step c) may be carried out by reduction of the ambient pressure and/or elevation of the ambient temperature.

In the non-prefoamed state the expandable thermoplastic polymer particles according to the invention having a recyclate content preferably have an average particle diameter in the range from 0.1 to 5 mm, preferably from 0.3 to 3 mm, particularly preferably from 0.5 to 2 mm. Expandable polymer particles having a narrow particle size distribution and an average particle diameter in the recited range result in better filling of the mold during welding of the polymer particles to afford a molded part. They allow for the design of more delicate molded parts and for an improved molded part surface.

In a further preferred embodiment the expandable thermoplastic polymer particles having a recyclate content are prefoamed. The resulting expandable polymer particles are preferably foamed to an average diameter in the range from 0.2 to 10 mm, preferably from 0.3 to 5 mm, particularly preferably from 0.5 to 4 mm. The final foaming of the prefoamed (pre-expanded) polymer particles may then be carried out in a downstream processing step.

The specific density of the prefoamed polymer particles having a recyclate content is preferably in the range from 10 to 250 g/L, particularly preferably 20 to 200 g/L, particularly preferably 25 to 150 g/L and particularly preferably 30 to 100 g/L.

In the prefoamed state the expandable thermoplastic polymer particles preferably have an average cell size between 50 and 400 μm, more preferably between 100 and 300 μm.

The expandable thermoplastic polymer particles according to the invention having a recyclate content can be introduced into a mold which is then closed and has hot air or steam passed through it to heat it. The heating may alternatively be effected by radio waves or infrared radiation. This causes the polymer particles to expand further, ideally until complete filling of the cavity, thus forming a foam molded article. The processing pressure is selected low enough to maintain the pore structure in the cell membranes. The pressure is typically in the range from 0.5 to 1.0 bar.

The expandable thermoplastic polymer particles according to the invention may be subjected to further processing (e.g. foamed) immediately after production or initially stored and only subsequently supplied to the intended use. The application of a coating to the surface of the inventive expandable thermoplastic polymer particles is not necessary but may optionally be carried out if for example an antistatic finish is desired. Antistatic coatings are known to those skilled in the art. Examples of antistatic coatings include quaternary ammonium salts, polyoxyethylene-alkylphenol ethers, glycerol esters, stearic acid monoglyceride, stearic acid triglyceride, ethylene-bis-stearamide, polyethylene glycol sorbitan monooleate, zinc stearate, sodium alkanesulfonate, bis(2-hydroxyethyl) octylmethylammonium polyvinyl propionate and surfactants. Suitable antistatic coatings are commercially available for example under the trade names Larostat® (BASF, Germany), Neostatic® (Peter H. Urdahl GmbH, Germany) or Chemstat® (PCC Chemax Inc., Poland).

### Use

The invention further provides for the use of the inventive expandable thermoplastic polymer particles having a recyclate content for production of molded parts such as foam molded articles which are preferably formed by expanding and welding the expandable polymer particles using hot air, steam, radio waves and/or infrared radiation. The obtained molded parts may be employed in numerous applications, especially as insulation material, damping material, packaging material or as lightweight construction material, for example in the automotive sector.

The molded part preferably has a specific density of less than 250 g/L, preferably of less than 200 g/L, particularly preferably of less than 150 g/L.

The molded part preferably has a compressive strength at 10% elongation of more than 250 kPa.

The molded part preferably has a flexural modulus of more than 15 MPa.

The invention will now be illustrated by the examples, figures and claims which follow.

### Examples

In a co-rotating twin-screw extruder (type ZK25P, Collin GmbH) having a screw diameter of 30 mm and a length-to-diameter ratio of 42, polymer mixtures consisting of a recycled acrylonitrile-butadiene-styrene copolymer (rABS), obtainable for example under the trade name Terluran® ECO (INEOS Styrolution), and the primary polymer acrylonitrile-butadiene-styrene copolymer (ABS) were melted with the blowing agent n-pentane and optionally the nucleating agent talc at 200-240° C. and thus homogeneously mixed. Performed experiments are reported in table 1.

The resulting polymer mixture (I) was then cooled in a single-screw extruder (type E 45 M, Collin GmbH) having a screw diameter of 45 mm and a length-to-diameter ratio of 30 and the melt was extruded through a heated perforated plate. The polymer strand was subjected to underwater pelletization to obtain blowing agent-laden minipellet material of narrow particle size distribution. The counterpressure in the underwater pelletization was adjusted to 8 to 11 bar.

The blowing agent-laden minipellet material was then prefoamed in an X-line 3 prefoamer (Kurtz GmbH). The prefoamed polymer particles were welded in a TVZ 162/100 PP molding machine (Teubert Maschinenbau GmbH) at about 120-125° C. to produce test specimens for measurement of thermal and mechanical properties.

The density of the prefoamed particles was determined using an AG245 density balance (Mettler Toledo) according to ISO 1183.

The cell size was measured by measuring cell diameters using a profilometer (Keyence) and ImageJ software on foam particles cut in half by cryofracture. 50 cells per particle of three particles per material were evaluated in each case.

The thermal characterization of the test specimens was carried out according to DIN EN 12667 using an HMF Lambda Small heat flow meter (Netzsch) with test specimens having dimensions of 200×200×20 mm and a temperature gradient of 20 K.

Mechanical characterization of the test specimens was carried out by means of a 3-point bending test using a 1485 universal tester (Zwick Roell) according to ISO 1209 on test specimens having dimensions of 120×25×20 mm at a preload force of 1 N and a test speed of 10 mm/min. Static compression tests were performed according to DIN EN ISO 844 using a Z050 universal testing machine (Zwick Roell) on test specimens having dimensions of 40×20×20 mm with a foam skin at a preload force of 10 N.

The results are reported in table 1. The example pairs 1 and 2 and 3 and 4 each have the same recyclate content but differ in their degree of foaming which is specifically adjusted by varying the process parameters. The degree of foaming is reflected in the foam density. Comparison of mechanical and thermal properties should in each case employ foams of identical density since these properties are strongly influenced by foam density. Examples 1 and 3 and comparative examples 5 and 6 are foamed to a greater extent than examples 2 and 4.

TABLE 1
Results of examples

| | | | | | Comparative | Comparative |
|---|---|---|---|---|---|---|
| | Example 1 | Example 2 | Example 3 | Example 4 | example 5 | example 6 |
| Recyclate | 50 | 50 | 70 | 70 | 0 | 0 |
| content in | | | | | | |
| polymer | | | | | | |
| composition | | | | | | |
| [% by wt.] | | | | | | |
| Primary | 50 | 50 | 30 | 30 | 100 | 99.6 |
| polymer | | | | | | |
| content in | | | | | | |
| polymer | | | | | | |
| composition | | | | | | |
| [% by wt.] | | | | | | |
| Nucleating | 0 | 0 | 0 | 0 | 0 | 0.4 |
| agent content | | | | | | |
| in polymer | | | | | | |
| composition | | | | | | |
| [% by wt.] | | | | | | |
| Foam density | 59 | 99 | 59 | 116 | 50 | 55 |
| of prefoamed | | | | | | |
| particles | | | | | | |
| [g/L] | | | | | | |
| Average cell | 285 | 130 | 217 | 137 | 817 | 194 |
| size in | | | | | | |
| prefoamed | | | | | | |
| particle [μm] | | | | | | |
| Thermal | 0.0333 | 0.0368 | 0.0327 | 0.0378 | 0.0378 | 0.0355 |
| conductivity | | | | | | |
| at 25° C. | | | | | | |
| [W/m K] | | | | | | |
| Compressive | 288 | 587 | 264 | 773 | 140 | 250 |
| strength at 10% | | | | | | |
| elongation | | | | | | |
| [kPa] | | | | | | |
| Flexural | 18.7 | 35.8 | 19.7 | 40.6 | 8.2 | 13.1 |
| modulus | | | | | | |
| [MPa] | | | | | | |

Comparison of inventive examples 1 and 3 (with a recyclate content of 50% and 70% by weight respectively based on the total weight of the polymer composition) with comparative examples 5 and 6 (no recyclate content) reveals the following:

The thermal conductivity of inventive examples 1 and 3 is markedly lower than in the case of noninventive comparative examples 5 and 6, i.e. the insulation effect of the inventive examples is much better when the polymer composition contains a recyclate content (see also FIG. 1). The foam from comparative example 5 was produced without nucleating agent, thus leading to inhomogeneous foam structures in the case of the polymer compositions without recyclate content. The use of nucleating agents improves the foam structure (comparative example 6) but the thermal conductivity is still higher (and the insulation effect thus poorer) than that of the foams having a recyclate content (examples 1 and 3). Very readily insulating foams are producible even without nucleating agents when the polymer composition contains a high recyclate content.

Inventive examples 1 and 3 moreover show a finer and more homogeneous cell structure than comparative example 5 (see FIGS. 4 and 5). FIG. 4 shows the cell structure of an inventive polymer foam with 50% by weight recyclate content according to example 1. FIG. 5 shows the cell structure of a noninventive foam without recyclate content according to comparative example 5. The foam without recyclate content is inhomogeneous with large cells. In the noninventive foams a good cell structure is achievable only through the use of nucleating agents, as shown in FIG. 6. FIG. 6 shows the foam structure of comparative example 6; it is a noninventive foam without a recyclate content but with nucleating agent. The average cell size of inventive example 1 is markedly smaller than the cell size in noninventive comparative example 5 without nucleating agent, thus indicating that the cell structure in the inventive examples is much better than in the noninventive examples.

Test specimens produced from the inventive compositions (examples 1 and 3) have a better compressive strength than test specimens according to the noninventive comparative examples 5 and 6 (see also FIG. 2). Comparative example 5 (without nucleating agent) shows only a very low compressive strength. The addition of nucleating agents in comparative example 6 does improve the compressive strength but does not achieve the good values of the inventive examples with recyclate content. Here too it is apparent that the inventive compositions having a high recyclate content are suitable for producing foams with very good compressive strength even without addition of nucleating agents.

The measured data for the flexural modulus of the test specimens also clearly show that the inventive foams having a recyclate content have markedly improved properties compared to the noninventive foams. In the case of the latter the addition of nucleating agents does improve the flexural modulus (comparative example 6) but the good values of the inventive examples having a recyclate content are still not achieved (see also FIG. 3).

The use of a high recyclate content thus makes it possible to produce foam bodies having better mechanical and thermal properties than foam bodies produced only from primary material even without addition of nucleating agents.

### EXPLANATION OF THE FIGURES

FIG. 1 shows a graphic representation of the experimentally obtained data for thermal conductivity at 25° C. in W/m*K for examples 1 and 3 and comparative examples 5 and 6.

FIG. 2 shows a graphic representation of the experimentally obtained data for compressive strength at 10% elongation in kPa for examples 1 and 3 and comparative examples 5 and 6.

FIG. 3 shows a graphic representation of the experimentally obtained data for flexural modulus in MPa for examples 1 and 3 and comparative examples 5 and 6.

FIG. 4 shows an electron micrograph of an inventive prefoamed particle obtained from example 1.

FIG. 5 shows an electron micrograph of a noninventive prefoamed particle obtained from comparative example 5.

FIG. 6 shows an electron micrograph of a noninventive prefoamed particle obtained from comparative example 6.

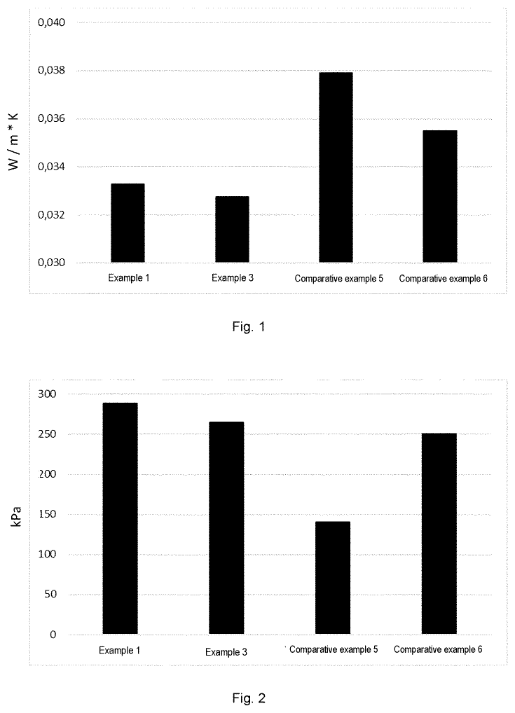

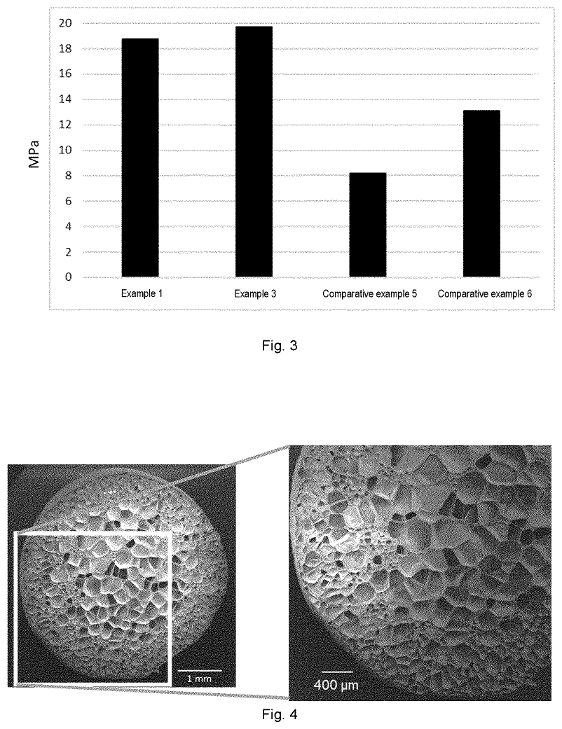

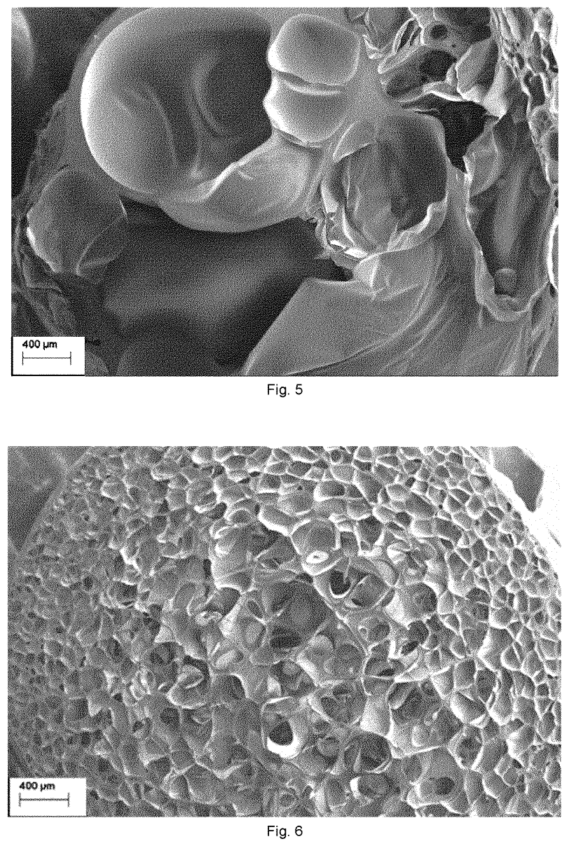

1-15. (canceled)

16. An expandable thermoplastic polymer particle comprising:
A: 10% to 98% by weight, based on the total weight of (A), (B), (C), (D), and (E), of at least one recyclate (A),
wherein the at least one recyclate (A) comprises at least one styrene polymer (A-1), consists predominantly of styrene polymers, and has undergone at least one separate thermal compounding step;
B: 1% to 89% by weight, based on the total weight of (A), (B), (C), (D), and (E), of at least one primary polymer (B),
wherein the at least one primary polymer (B) comprises at least one styrene polymer (B-1);
C: 1% to 10% by weight, based on the total weight of (A), (B), (C), (D), and (E), of at least one blowing agent (C);
D: 0% to 3% by weight, based on the total weight of (A), (B), (C), (D), and (E), of at least one nucleating agent (D); and
E: 0% to 8% by weight, based on the total weight of (A), (B), (C), (D), and (E), of at least one additive (E),
wherein (A) and (B) sum up to 79% to 99% by weight, based on the total weight of (A), (B), (C), (D), and (E), and
wherein the expandable thermoplastic polymer particle contains substantially no further polymers in addition to the at least one recyclate (A) and the at least one primary polymer (B).

17. The expandable thermoplastic polymer particle of claim 16, wherein the at least one recyclate (A) and the at least one primary polymer (B) each comprise at least one polymer selected from the group consisting of styrene-acrylonitrile copolymers (SAN), acrylonitrile-butadiene-styrene copolymers (ABS), acrylate-styrene-acrylonitrile copolymers (ASA), methyl methacrylate-acrylonitrile-butadiene-styrene copolymers (MABS), methyl methacrylate-butadiene-styrene copolymers (MBS), α(alpha)-methylstyrene-acrylonitrile copolymers (AMSAN), styrene-methyl methacrylate copolymers (SMMA), styrene-maleic anhydride copolymers (SMA), styrene-acrylonitrile-maleic anhydride copolymers (SANMA), styrene-N-phenylmaleimide copolymers, styrene-acrylonitrile-N-phenylmaleimide copolymers, styrene-imide-maleic anhydride copolymers, styrene-imide-acrylonitrile-maleic anhydride copolymers, amorphous polystyrene (PS), and impact-modified polystyrene (HIPS).

18. The expandable thermoplastic polymer particle of claim 16, wherein the at least one recyclate (A) and the at least one primary polymer (B) are each at least one polymer selected from the group consisting of styrene-acrylonitrile copolymers (SAN), acrylonitrile-butadiene-styrene copolymers (ABS), and acrylate-styrene-acrylonitrile copolymers (ASA).

19. The expandable thermoplastic polymer particle of claim 16, wherein an average particle diameter of the expandable thermoplastic polymer particle in a non-prefoamed state ranges from 0.1 to 5 mm.

20. The expandable thermoplastic polymer particle of claim 16, wherein the expandable thermoplastic polymer particle is prefoamed to an average particle diameter ranging from 0.2 to 10 mm.

21. The expandable thermoplastic polymer particle of claim 16,
wherein the expandable thermoplastic polymer particle comprises two or more recyclates (A) and two or more primary polymers (B), and
wherein the two or more recyclates (A) and the two or more primary polymers (B) are miscible with each other.

22. The expandable thermoplastic polymer particle of claim 16, wherein an average cell size of the expandable thermoplastic polymer particle in a prefoamed state ranges from 50 to 400 μm.

23. A process for producing the expandable thermoplastic polymer particle of claim 16,
wherein the process comprises the following steps:
a) admixing a mixture of the at least one recyclate (A) and the at least one primary polymer (B) with the at least one blowing agent (C) and optionally the at least one nucleating agent (D) and/or the at least one additive (E) to form a polymer mixture (I);
b) pelletizing the polymer mixture (I) to obtain the expandable thermoplastic polymer particle; and
c) optionally pre-expanding the expandable thermoplastic polymer particle.

24. The process of claim 23, wherein at least step a) is carried out under a pressure which exceeds atmospheric pressure.

25. The process of claim 23,
wherein steps a) and b) are carried out in an extruder, and
wherein the process further comprises pelletizing the polymer mixture (I) underwater at a water pressure ranging from 1.5 to 11 bar.

26. The process of claim 23, wherein steps a) and b) are carried out in an autoclave.

27. The process of claim 23, wherein steps a) and b) are carried out in a suspension.

28. A method for producing molded parts from a plurality of the expandable thermoplastic polymer particles of claim 16, the method comprising:
pre-expanding the plurality of the expandable thermoplastic polymer particles; and
welding the plurality of the pre-expanded thermoplastic polymer particles using hot air, steam, radio waves, and/or infrared radiation to form the molded parts.

29. The method of claim 28, wherein the molded parts have a specific density of less than 250 g/L.

30. The method of claim 28, wherein the molded parts have a compressive strength at 10% elongation of more than 250 kPa.

31. The method of claim 28, wherein the molded parts have a flexural modulus of more than 15 MPa.

32. The expandable thermoplastic polymer particle of claim 19, wherein the average particle diameter of the expandable thermoplastic polymer particle in the non-prefoamed state ranges from 0.3 to 3 mm.

33. The expandable thermoplastic polymer particle of claim 20, wherein the expandable thermoplastic polymer particle is prefoamed to the average particle diameter ranging from 0.3 to 5 mm.

34. The expandable thermoplastic polymer particle of claim 22, wherein the average cell size of the expandable thermoplastic polymer particle in a prefoamed state ranges from 100 to 300 μm.

35. The process of claim 24, wherein steps a) and b) are carried out under a pressure which exceeds atmospheric pressure.
